(19) United States
(12) Patent Application Publication
(10) Pub. No.: US 2026/0155859 A1
(43) Pub. Date: Jun. 4, 2026

(54) Communication Device, Article of Personal Protective Equipment and Method of Communication

(71) Applicant: 3M INNOVATIVE PROPERTIES COMPANY, St. Paul, MN (US)

(72) Inventor: Dana G. DeMeo, Matthews, NC (US)

(21) Appl. No.: 18/294,523

(22) PCT Filed: Aug. 3, 2022
(86) PCT No.: PCT/IB2022/057178

§ 371 Date: Feb. 1, 2024

Related U.S. Application Data
(60) Provisional application No. 63/203,879, filed on Aug. 3, 2021.

(51) Int. Cl. H04B 1/401; H04B 1/3827

(52) U.S. Cl. CPC H04B 1/401; H04B 1/3827

(57) ABSTRACT

A communication device for an article of a personal protective equipment includes a plurality of communication circuits, a switching circuit, and a controller. The plurality of communication circuits corresponds to a plurality of modulation schemes and a plurality of communication channels. The plurality of communication channels includes different bandwidths from each other. Each communication circuit is configured to modulate a signal using a corresponding modulation scheme for transmission over a corresponding communication channel. The switching circuit is configured to switch between the plurality of communication circuits and receive an input signal. The controller is communicably coupled with the plurality of communication circuits and the switching circuit and configured to determine a criticality level of the input signal, and control the switching circuit to switch between the plurality of communication circuits and select one communication circuit from the plurality of communication circuits based on the criticality level of the input signal.

### TECHNICAL FIELD

The present disclosure relates to a communication device, an article of personal protective equipment (PPE) including the communication device, and a method of communication for the article of PPE.

### BACKGROUND

Articles of personal protective equipment (PPE) may be used by personnel working in hazardous environments. In such hazardous environments, a communication system may be required to communicate information and telemetry data with other personnel (e.g., emergency responders) or a central base station in real-time.

### SUMMARY

According to a first aspect, a communication device for an article of a personal protective equipment (PPE) is disclosed. The communication device includes a plurality of communication circuits corresponding to a plurality of modulation schemes and a plurality of communication channels. The plurality of communication channels includes different bandwidths from each other. Each communication circuit is configured to modulate a signal using a corresponding modulation scheme from the plurality of modulation schemes for transmission over a corresponding communication channel from the plurality of communication channels. The communication device further includes a switching circuit configured to selectively switch between the plurality of communication circuits. The switching circuit is configured to receive an input signal. The communication device further includes a controller communicably coupled with the plurality of communication circuits and the switching circuit. The controller is configured to determine a criticality level of the input signal. The controller is further configured to control the switching circuit to switch between the plurality of communication circuits and select one communication circuit from the plurality of communication circuits based on the criticality level of the input signal, such that the one of the communication circuit receives the input signal and modulates the input signal using the corresponding modulation scheme for transmission over the corresponding communication channel.

According to a second aspect, an article of personal protective equipment includes the communication device of the first aspect.

According to a third aspect, a method of communication for an article of personal protective equipment is disclosed. The method includes providing a plurality of communication circuits corresponding to a plurality of modulation schemes and a plurality of communication channels. The plurality of communication channels includes different bandwidths from each other. Each communication circuit is configured to modulate a signal using a corresponding modulation scheme from the plurality of modulation schemes for transmission over a corresponding communication channel from the plurality of communication channels. The method includes receiving an input signal by the article of personal protective equipment. The method further includes determining a criticality level of the input signal. The method further includes controlling a switching circuit to switch between the plurality of communication circuits in order to select one communication circuit from the plurality of communication circuits based on the criticality level of the input signal, such that the one communication circuit receives the input signal. The method further includes modulating, using the one communication circuit, the input signal using the corresponding modulation scheme for transmission over the corresponding communication channel.

### BRIEF DESCRIPTION OF DRAWINGS

Exemplary embodiments disclosed herein may be more completely understood in consideration of the following detailed description in connection with the following figures. The figures are not necessarily drawn to scale. Like numerals used in the figures refer to like components. When referring to the elements collectively or to a non-specific one or more of the elements, the small letter designation may be eliminated. However, it will be understood that the use of a number to refer to a component in a given figure is not intended to limit the component in another figure labeled with the same number.

FIG. 1 illustrates a schematic perspective view of an article of personal protective equipment (PPE) including a communication device, in accordance with an embodiment of the of the present disclosure;

FIG. 2 illustrates a detailed block diagram of the communication device of the article of PPE, in accordance with an embodiment of the of the present disclosure;

FIGS. 3A-3C illustrate schematic views of the communication device of FIG. 2 in different states, in accordance with an embodiment of the of the present disclosure;

FIG. 4 illustrates a detailed block diagram of a memory communicably coupled to a controller, in accordance with an embodiment of the present disclosure;

FIG. 5 illustrates a detailed block diagram of the communication device of the article of PPE, in accordance with another embodiment of the of the present disclosure;

FIGS. 6A-6B illustrate schematic views of the communication device of FIG. 5 in different states, in accordance with an embodiment of the of the present disclosure;

FIGS. 7A and 7B illustrate schematic views of first and second communication channels, respectively, in accordance with an embodiment of the present disclosure;

FIG. 8 illustrates a schematic view of different modes of the communication device, in accordance with an embodiment of the present disclosure;

FIGS. 9A and 9B illustrate flowcharts of processes executed by the communication device in a normal mode and in an administrative mode, respectively, in accordance with an embodiment of the present disclosure; and

FIG. 10 is a flowchart of a method of communication for the article of personal protective equipment, in accordance with an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the following disclosure, the following definitions are adopted.

As used herein, all numbers should be considered modified by the term “about”. As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20 % for quantifiable properties).

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, “at least one of A and B” should be understood to mean “only A, only B, or both A and B”.

As used herein, a “communication device” generally includes a transceiver, and/or other devices for communicating with other devices directly or via a network, and/or a user interface for communicating with one or more users.

As used herein, a “user interface” generally includes a display, mouse, keyboard, button, touchpad, touch screen, microphone, speaker, LED, light, joystick, switch, buzzer, bell, and/or other user input/output device for communicating with one or more users.

As used herein, the term “network” may be associated with transmission of messages, packets, signals, and/or other forms of information between and/or within one or more network devices. In some examples, the network may include one or more wired and/or wireless networks operated in accordance with any communication standard that is or becomes known or practicable.

As used herein, the term “communication channel” may refer to a path, a conduit, a logical channel, or any means of communication that enables or supports a communication interaction or an exchange of information between two or more devices or parties. The communication channel may be wired or wireless.

As used herein, the term “bandwidth” may refer to a data throughput capacity of a communication channel.

As used herein, the term “signal,” may include, but is not limited to, one or more electrical signals, optical signals, electromagnetic signals, analog and/or digital signals, one or more computer instructions, a bit and/or bit stream, or the like.

As used herein, the term “hazardous or potentially hazardous environmental conditions” may refer to environmental conditions that may be harmful to a human being, such as high noise levels, high ambient temperatures, lack of oxygen, presence of explosives, exposure to radioactive or biologically harmful materials, and exposure to other hazardous substances. Depending upon the type of safety equipment, environmental conditions and physiological conditions, corresponding thresholds or levels may be established to help define hazardous and potentially hazardous environmental conditions.

As used herein, the term “hazardous or potentially hazardous environments” may refer to environments that include hazardous or potentially hazardous environmental conditions. The hazardous or potentially hazardous environments may include, for example, chemical environments, biological environments, nuclear environments, fires, industrial sites, construction sites, agricultural sites, mining sites, or manufacturing sites.

As used herein, the term “an article of personal protective equipment (PPE)” may include any type of equipment or clothing that may be used to protect a user from hazardous or potentially hazardous environmental conditions. In some examples, one or more individuals, such as the users, may utilize the article of PPE while engaging in tasks or activities within the hazardous or potentially hazardous environment.

Examples of the articles of PPE may include, but are not limited to, hearing protection (including ear plugs and ear muffs), respiratory protection equipment (including disposable respirators, reusable respirators, powered air purifying respirators, self-contained breathing apparatus and supplied air respirators), facemasks, oxygen tanks, air bottles, protective eyewear, such as visors, goggles, filters or shields (any of which may include augmented reality functionality), protective headwear, such as hard hats, hoods or helmets, protective shoes, protective gloves, other protective clothing, such as coveralls, aprons, coat, vest, suits, boots and/or gloves, protective articles, such as sensors, safety tools, detectors, global positioning devices, mining cap lamps, fall protection harnesses, exoskeletons, self-retracting lifelines, heating and cooling systems, gas detectors, and any other suitable gear configured to protect the users from injury. The articles of PPE may also include any other type of clothing or device/equipment that may be worn or used by the users to protect against extreme noise levels, extreme temperatures, fire, reduced oxygen levels, explosions, reduced atmospheric pressure, radioactive and/or biologically harmful materials.

Typically, articles of personal protective equipment (PPE) may be used by personnel working in hazardous or potentially hazardous environments, for example, burning buildings. In such hazardous or potentially hazardous environments, there is a need for communicating information and telemetry data with devices of other personnel (e.g., emergency responders) or a central base station in real-time. The information and the telemetry data may include data having different criticalities, for example, higher critical data and comparatively lower critical data. The higher critical data may include a man-down alarm and the lower critical data may include videos or images, which may be critical data but less critical than the higher critical data. The higher critical data is generally transmitted via a low-bandwidth radio. However, the low-bandwidth radio may not be suitable for communication of the lower critical data, as the lower critical data may require a higher bandwidth. In some cases, a separate radio may be utilized for communication of the lower critical data.

Therefore, a conventional communication system may include multiple radios to communicate data having different criticalities, such as the low-bandwidth radio and the separate radio to communicate the higher critical data and the lower critical data, respectively. However, usage of the multiple radios in the conventional communication system may increase a cost, a power requirement, and a size of the conventional communication system. Further, the usage of the multiple radios in the conventional communication system may further increase a complexity of the conventional communication system. This may be due to an interference between the multiple radios.

In order to overcome various drawbacks of the prior art, the present disclosure discloses a communication device for an article of PPE, an article of PPE including the communication device, and a method of communication for the article of PPE.

The communication device includes a plurality of communication circuits corresponding to a plurality of modulation schemes and a plurality of communication channels. The plurality of communication channels includes different bandwidths from each other. Each communication circuit is configured to modulate a signal using a corresponding modulation scheme from the plurality of modulation schemes for transmission over a corresponding communication channel from the plurality of communication channels. The communication device further includes a switching circuit configured to selectively switch between the plurality of communication circuits. The switching circuit is configured to receive an input signal. The communication device further includes a controller communicably coupled with the plurality of communication circuits and the switching circuit. The controller is configured to determine a criticality level of the input signal. The controller is further configured to control the switching circuit to switch between the plurality of communication circuits and select one communication circuit from the plurality of communication circuits based on the criticality level of the input signal, such that the one of the communication circuit receives the input signal and modulates the input signal using the corresponding modulation scheme for transmission over the corresponding communication channel.

The communication device of the present disclosure may allow dynamic selection of an appropriate modulation scheme depending on the criticality level of the input data. This may allow a more reliable communication of the input signals having different criticality levels between the article of PPE and an external system via a single device (i.e., the communication device). For example, the low-bandwidth radio and the separate radio may not be required to transmit the input signal having the higher criticality level and the input signal having the lower criticality level, respectively, between the article of PPE and the external system. Therefore, the communication device may be cheaper than the conventional communication systems, may have a less power requirement than the conventional communication systems, and may have a reduced size than the conventional communication systems. Further, the communication device may not cause an interference as caused by the multiple radios in the conventional communication systems. The communication device may therefore be less susceptible to interference, thereby allowing clear communication.

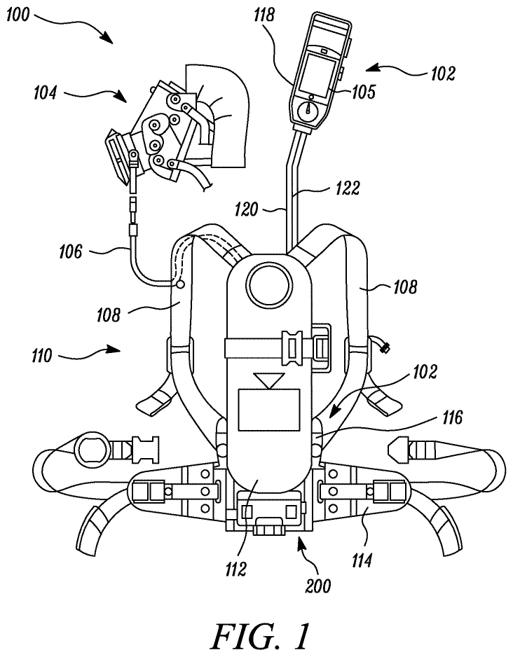

Referring now to the figures, FIG. 1 is a schematic perspective view of an article of personal protective equipment (PPE) 100, according to an embodiment of the present disclosure. The article of PPE 100 may interchangeably be referred to as “the article 100”.

In some embodiments, the article 100 may be used by a user (not shown) in an environment, such as a hazardous or potentially hazardous environment.

In some examples, the user of the article 100 may be any emergency personnel, such as firefighters, first responders, healthcare professionals, paramedics, HAZMAT workers, security personnel, law enforcement personnel, or any other personnel working in the environment. In the cases where the user is a firefighter, the article 100 may be worn by the firefighter in the environment.

In some embodiments, the article 100 may include a breathing apparatus. In the illustrated embodiment of FIG. 1, the article 100 includes a self-contained breathing apparatus (SCBA). In some other embodiments, the article 100 may include a respiratory protective equipment (RPS), a powered air purifying respirator (PAPR), a non-powered purifying respirator (APR), a self-retracting lifeline (SRL), or combinations thereof.

In some embodiments, the article 100 includes a backpack 110 including shoulder straps 108 and a belt 114, that is wearable by the user. The article 100 further includes an air tank 112 mounted on the backpack 110. The air tank 112 may include pressurized breathable air. In some embodiments, the article 100 may include a headgear 104 that may be worn on a head of the user. The headgear 104 may be used to provide protection to the head of the user. The headgear 104 may include a face mask, safety goggles, a safety hat, or combinations thereof.

The headgear 104 may include a heads-up display (HUD). The HUD may display one or more parameters to the user of the article 100. The one or more parameters may include parameters associated with a state of health of the article 100, parameters associated with the environment of the article 100, or a combination thereof. In some embodiments, the parameters associated with the state of health of the article 100 may include a remaining level of air in the air tank 112, a battery level of a battery pack (not shown) of the article 100, and the like. In some embodiments, the parameters associated with the environment of the article 100 may include a temperature of the environment, a level of smoke or dust in the environment, a level of any gases in the environment, a location of other emergency personnel in the environment, and the like. In some embodiments, the HUD may display a notification including instructions or information received from a command gateway (not shown), and/or from other portable devices (not shown). The remaining level of air in the air tank 112 may be ascertained via a pressure sensor (not shown) located at an outlet pathway of the air tank 112. The headgear 104 may further include a hearing device (not shown). In some examples, the hearing device may include a wired/wireless headphone and/or an earphone. In some other examples, the hearing device may include a hearing protection device, such as, a pair of earmuffs.

In some embodiments, the article 100 may include an air line/data line 106, which supplies air from the air tank 112 to the headgear 104 (e.g., a face mask) of the user, and provides data communications and power supply to the HUD.

In some embodiments, a communication device 200 for the article 100 may be disposed on the article 100. In the illustrated embodiment of FIG. 1, the communication device 200 is disposed at a base of the air tank 112, on the belt 114. However, in some other embodiments, the communication device 200 may be disposed at any location on the article 100, for example, on any one of the shoulder straps 108 so that the user may easily access the communication device 200. In some embodiments, the article 100 includes the communication device 200.

In some embodiments, the article 100 further includes a personal alert safety system (PASS) device 102. The PASS device 102 may include a PASS control console 118 and an alert unit 116. The PASS control console 118 may hang from an end of a pressure data line 120, connected via a pressure reducer (not shown) to the air tank 112, and a reinforced cable sheath 122. The alert unit 116 may be carried in a recess in the backpack 110. Therefore, in the illustrated embodiment of FIG. 1, the PASS device 102 is shown to be distributed at two locations on the article 100-at the end of the reinforced cable sheath 122, and in the recess of the backpack 110. The article 100 may further include a personal digital assistance (PDA) device 105. The PDA device 105 may be located on the PASS device 102.

In some embodiments, the PASS device 102 is communicably coupled to the communication device 200. In some embodiments, the reinforced cable sheath 122 carries electronic cables that connect the communication device 200 and the PASS device 102.

In some embodiments, the communication device 200 and the PASS device 102 may be powered by the battery pack of the article 100. In some other embodiments, the communication device 200 and the PASS device 102 may include respective stand-alone batteries. Examples of the batteries may include coin cells, Lithium Ion batteries, and the like. In some examples, the batteries may be rechargeable. Rechargeable batteries, such as Lithium Ion batteries, may provide a compact and long-life source of power.

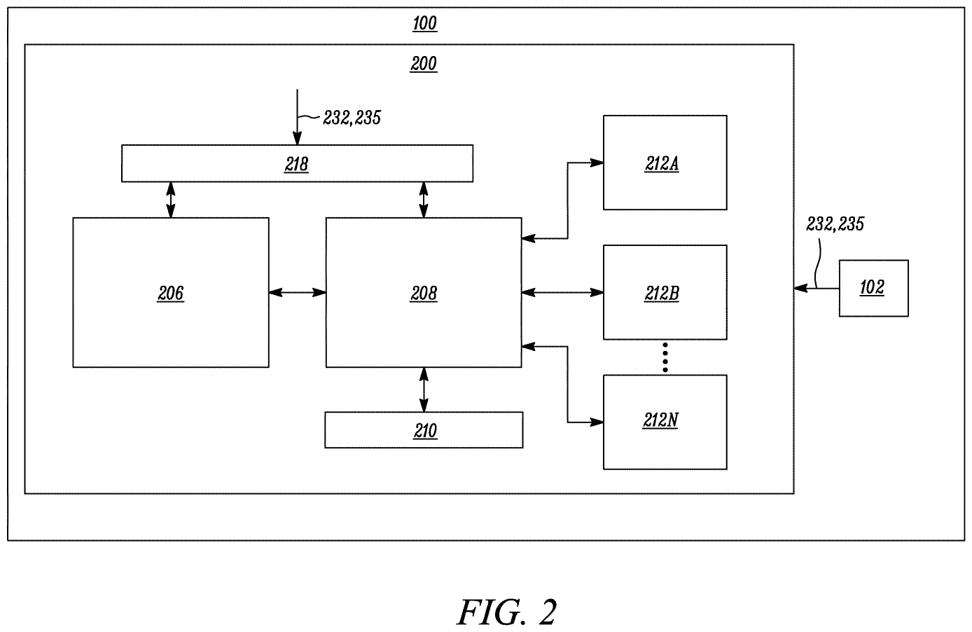

FIG. 2 illustrates a detailed schematic block diagram of the article 100 including the communication device 200 and the PASS device 102, according to an embodiment of the present disclosure.

The communication device 200 includes a plurality of communication circuits 212A-212N (collectively, the plurality of communication circuits 212), a switching circuit 206, and a controller 208.

The controller 208 is communicably coupled to the plurality of communication circuits 212 and the switching circuit 206.

In some embodiments, the controller 208 may include any suitable type of processing circuitry, such as one or more general-purpose controller or microcontroller or processors (e.g., ARM-based processors), a Digital Signal Processor (DSP), a Programmable Logic Device (PLD), an Application-Specific Integrated Circuit (ASIC), a Field-Programmable Gate Array (FPGA), etc.

In some embodiments, the PASS device 102 is configured to generate an input signal 232. The input signal 232 includes an input data 235. In some embodiments, the communication device 200 includes a transceiver 218 communicably coupled to at least one of the switching circuit 206 and the controller 208. In the illustrated embodiment of FIG. 2, the transceiver 218 is communicably coupled to each of the switching circuit 206 and the controller 208. The transceiver 218 is configured to wirelessly receive the input signal 232.

In some embodiments, the PASS device 102 may generate the input signal 232 based on inputs from various sensors, for example, a motion sensor or an air sensor. The motion sensor may detect motion of the user of the article 100, while the air sensor may detect the air pressure in the air tank 112 (shown in FIG. 1). In some examples, the PASS device 102 may generate the input signal 232 upon detecting the air tank 112 is low on air, for example, less than 33% of its capacity. In some other examples, the PASS device 102 may generate the input signal 232 upon detecting that there is no movement of the user for a predefined period of time, for example, 30 seconds. In some examples, the alert unit 116 (shown in FIG. 1) of the PASS device 102 may also generate an alarm upon detecting that the user has been motionless for the predefined period of time.

In some embodiments, the communication device 200 further includes a memory 210 communicably coupled to the controller 208.

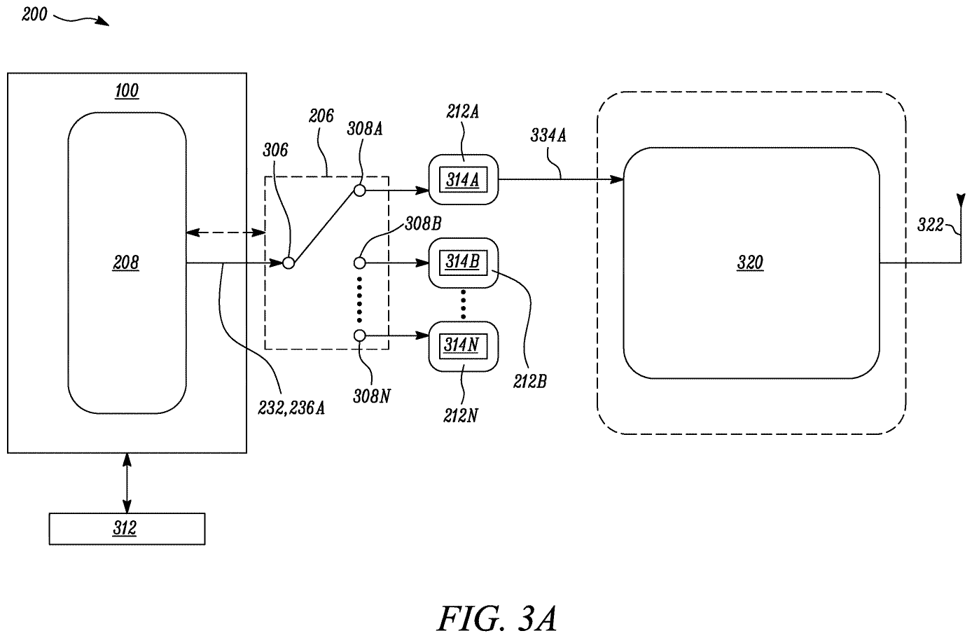

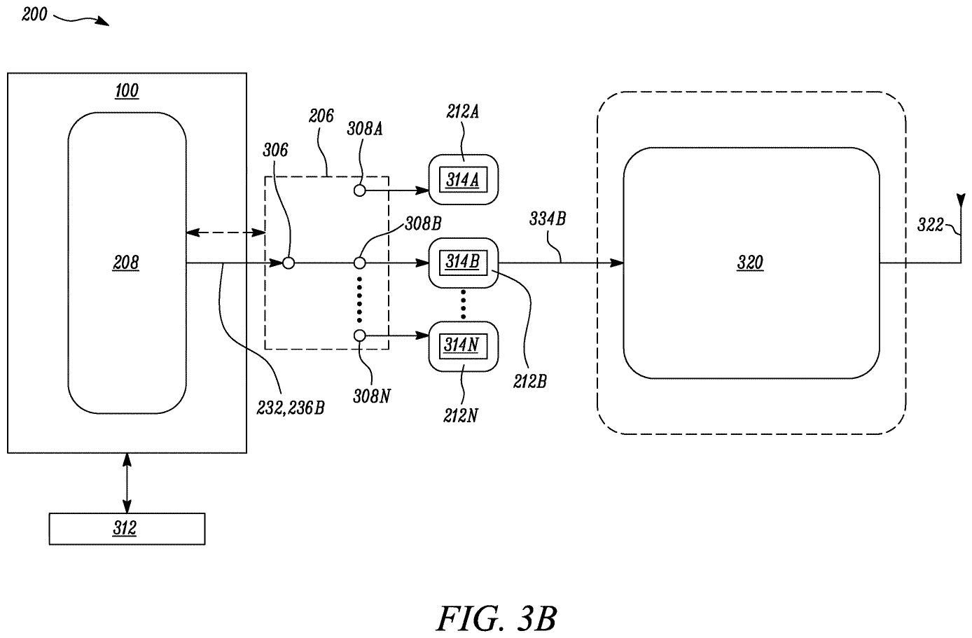

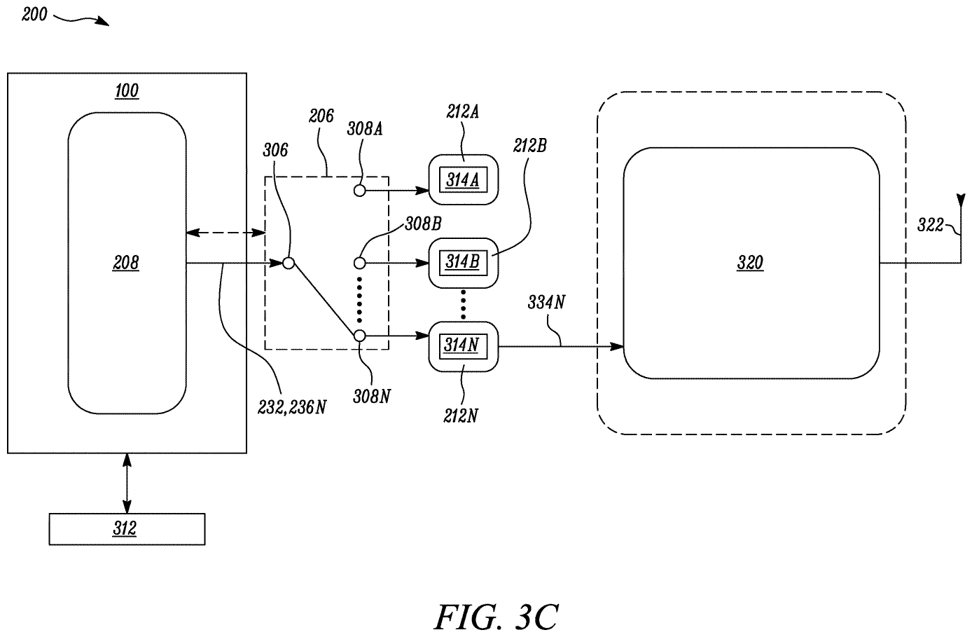

FIGS. 3A-3C illustrate detailed schematic views of the communication device 200 in different states. In some embodiments, the input signal 232 is received from at least one of the article 100 and an external device 312 communicably coupled to the article 100. In some embodiments, the external device 312 may include an imaging unit, a navigation unit, a microphone, and/or biometric sensors, communicably coupled to the article 100. The biometric sensors may include sensors for measuring a body temperature, a pulse rate, CO2 levels, and other physiological parameters of the user.

Referring to FIGS. 3A to 3C, the plurality of communication circuits 212 correspond to a plurality of modulation schemes 314A-314N (collectively, the plurality of modulation schemes 314) and a plurality of communication channels. The plurality of communication channels include different bandwidths from each other.

Each communication circuit 212A-212N is configured to modulate a signal (e.g., the input signal 232) using a corresponding modulation scheme from the plurality of modulation schemes 314 for transmission over a corresponding communication channel from the plurality of communication channels. For example, the communication circuit 212A may be configured to modulate a signal using the modulation scheme 314A, the communication circuit 212B may be configured to modulate a signal using the modulation scheme 314B, and so forth.

In some embodiments, at least one of the plurality of modulation schemes 314 includes at least one of a long range (LoRa) network modulation scheme, a Bluetooth low energy (BLE) modulation scheme and a custom modulation scheme. The LoRa network modulation scheme may provide a low-bandwidth and a higher reliability communication. In addition, the LoRa network modulation scheme may provide a higher reliability and a greater range. The plurality of communication circuits 212 configured to modulate a signal (e.g., the input signal 232) using the LoRa network modulation scheme may consume less power, may be small in physical size, and have low cost.

In some embodiments, at least one other of the plurality of modulation schemes 314 includes at least one of a coded orthogonal frequency-division multiplexing (COFDM) modulation scheme, Wi-Fi, WiMax, cellular communication (3G, 4G, LTE, 5G), wide area network (WAN), and custom modulation scheme. The COFDM modulation scheme may provide a high-bandwidth and a lower reliability communication. In some embodiments, the COFDM modulation scheme may reduce the effects of multi-path and doppler effects.

Referring to FIGS. 3A to 3C, the switching circuit 206 is configured to receive the input signal 232. In some embodiments, the switching circuit 206 is configured to receive the input signal 232 from the controller 208. The switching circuit 206 is configured to selectively switch between the plurality of communication circuits 212.

In some embodiments, the switching circuit 206 includes an input terminal 306 configured to receive the input signal 232. The switching circuit 206 further includes a plurality of output terminals 308A-308N (collectively, the plurality of output terminals 308) corresponding to the plurality of communication circuits 212. For example, the output terminal 308A may correspond to the communication circuit 212A, the output terminal 308B may correspond to the communication circuit 212B, and so forth.

The controller 208 is further configured to control the switching circuit 206 to selectively couple one of the plurality of output terminals 308 to the input terminal 306. The switching circuit 206 may provide selective coupling of the output terminals 308 to the input terminal 306. Any suitable switching circuit capable of providing selective coupling described above may be used as the switching circuit 206. The switching circuit 206 may include a field-effect transistor (FET) and/or a junction transistor that is controlled, for example, by the controller 208. The switching circuit 206 may include other suitable electronic or electromagnetic switch devices, junction transistors, relays, or the like.

The controller 208 is configured to determine a criticality level of the input signal 232. The input signal 232 may include one criticality level from a plurality of criticality levels 236A-236N (collectively, the plurality of criticality levels 236). In some embodiments, the criticality level includes a higher criticality level 236A (shown in FIG. 3A), an intermediate criticality level 236B (shown in FIG. 3B), and a lower criticality level 236N (shown in FIG. 3C). In some embodiments, the plurality of criticality levels 236 includes more than one intermediate criticality levels (not shown). The plurality of criticality levels 236 may include graduated levels of criticality. For example, the higher criticality level 236A may have a highest level of criticality and the lower criticality level 236N may have a lowest level of criticality.

The controller 208 is further configured to control the switching circuit 206 to switch between the plurality of communication circuits 212 and select one communication circuit from the plurality of communication circuits 212 based on the criticality level of the input signal 232, such that the one communication circuit receives the input signal 232 and modulates the input signal 232 using the corresponding modulation scheme for transmission over the corresponding communication channel.

For example, the controller 208 is configured to control the switching circuit 206 to switch to the communication circuit 212A, such that the communication circuit 212A receives the input signal 232 upon determining that the input signal 232 has the higher criticality level 236A and modulates the input signal 232 using the modulation scheme 314A for transmission over the corresponding communication channel. In another example, the controller 208 is configured to control the switching circuit 206 to switch to the communication circuit 212B, such that the communication circuit 212B receives the input signal 232 upon determining that the input signal 232 has the intermediate criticality level 236B and modulates the input signal 232 using the modulation scheme 314B for transmission over the corresponding communication channel. In yet another example, the controller 208 is configured to control the switching circuit 206 to switch to the communication circuit 212N, such that the communication circuit 212N receives the input signal 232 upon determining that the input signal 232 has the lower criticality level 236N and modulates the input signal 232 using the modulation scheme 314N for transmission over the corresponding communication channel.

The communication channel corresponding to the modulation scheme 314N may have a greater bandwidth than the communication channels corresponding to the modulation schemes 314A, 314B, respectively. The communication channel corresponding to the modulation scheme 314B may have a greater bandwidth than the communication channel corresponding to the modulation scheme 314A and less bandwidth than the communication channel corresponding to the modulation scheme 314N.

In the illustrated embodiment of FIG. 3A, the input signal 232 has the higher criticality level 236A. Therefore, the switching circuit 206 switches to the communication circuit 212A, such that the communication circuit 212A receives the input signal 232. Specifically, the controller 208 controls the switching circuit 206 to selectively couple the output terminal 308A to the input terminal 306.

In the illustrated embodiment of FIG. 3B, the input signal 232 has the intermediate criticality level 236B. Therefore, the switching circuit 206 switches to the communication circuit 212B, such that the communication circuit 212B receives the input signal 232. Specifically, the controller 208 controls the switching circuit 206 to selectively couple the output terminal 308B to the input terminal 306.

In the illustrated embodiment of FIG. 3C, the input signal 232 has the lower criticality level 236N. Therefore, the switching circuit 206 switches to the communication circuit 212N, such that the communication circuit 212N receives the input signal 232. Specifically, the controller 208 controls the switching circuit 206 to selectively couple the output terminal 308N to the input terminal 306.

In some embodiments, the communication device 200 includes a transceiver 320 communicably coupled to each of the plurality of communication circuits 212. The transceiver 320 is configured to wirelessly transmit output signals 334A-334N (collectively, the output signals 334) received from a corresponding communication circuit 212 from the plurality of communication circuits 212. For example, the transceiver 320 is configured to wirelessly transmit the output signal 334A received from the communication circuit 212A, the output signal 334B received from the communication circuit 212B, and so forth.

In the illustrated embodiment of FIG. 3A, the transceiver 320 receives the output signal 334A from the communication circuit 212A as the communication circuit 212A modulates the input signal 232 having the higher criticality level 236A using the modulation scheme 314A for transmission over the corresponding communication channel.

In the illustrated embodiment of FIG. 3B, the transceiver 320 receives the output signal 334B from the communication circuit 212B as the communication circuit 212B modulates the input signal 232 having the intermediate criticality level 236B using the modulation scheme 314B for transmission over the corresponding communication channel.

In the illustrated embodiment of FIG. 3C, the transceiver 320 receives the output signal 334N from the communication circuit 212N as the communication circuit 212N modulates the input signal 232 having the lower criticality level 236N using the modulation scheme 314N for transmission over the corresponding communication channel.

In some embodiments, at least one of one the plurality of communication circuits 212, the switching circuit 206, and the transceiver 320 includes a software-defined radio (SDR).

In some embodiments, the transceiver 320 includes an antenna 322. In some embodiments, the communication device 200 may be configured to exchange data with one or more devices of personnel in the environment, one or more devices of personnel remote from the environment, and/or a central base station, via the antenna 322. In other words, the communication device 200 may include the antenna 322 for connecting the communication device 200 with a network. The central base station may include an incident command center, or a cloud infrastructure.

The network may transmit computer program instructions, data structures, program modules or other data over a wired or wireless substance by propagating a modulated data signal (e.g., the output signals 334), over the wired or wireless substance. The term “modulated data signal”, as used herein, means a signal that has one or more of its characteristics set or changed in such a manner as to encode information in the signal, thereby changing the configuration or state of the receiving device of the signal.

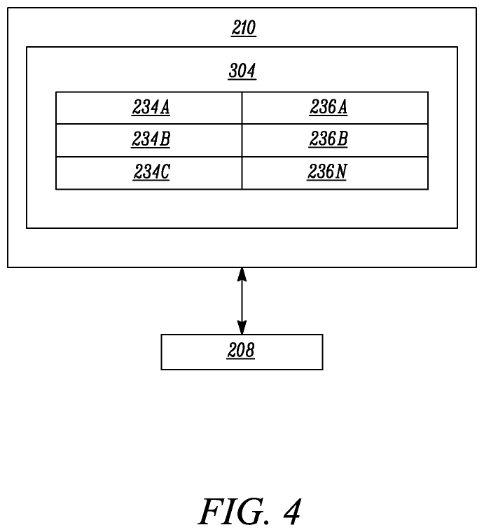

FIG. 4 illustrates a schematic block diagram of the memory 210 and the controller 208 communicably coupled to each other, according to an embodiment of the present disclosure.

In some embodiments, the memory 210 is configured to store a predetermined lookup table 304 including a plurality of data items 234A, 234B, 236C (collectively, the data items 234) and corresponding criticality levels. In the illustrated embodiment of FIG. 4, three data items are shown. However, the predetermined lookup table 304 may include any number of data items.

The memory 210 is further configured to store criticality levels of each of the plurality of data items. For example, the data item 234A has the higher criticality level 236A, the data item 234B has the intermediate criticality level 236B, and the data item 234C has the lower criticality level 236N.

In some embodiments, the controller 208 is further configured to determine the criticality level of the input signal 232 based on a match between the input data 235 and the plurality of data items 234A, 234B, 236C in the predetermined lookup table 304.

For example, if the input data 235 (shown in FIG. 2) of the input signal 232 (shown in FIG. 2) matches with the data item 234A, the controller 208 determines that the criticality level of the input signal 232 is the higher criticality level 236A. Further, if the input data 235 of the input signal 232 matches with the data item 234B, the controller 208 determines that the criticality level of the input signal 232 is the intermediate criticality level 236B. Furthermore, if the input data 235 of the input signal 232 matches with the data item 234C, the controller 208 determines that the criticality level of the input signal 232 is the lower criticality level 236N.

In some embodiments, the input data 235 may include a data type, a size, an identifier, or a source of the input signal 232. For example, if the input data 235 is the data type of the input signal 232, and the data type of the input signal 232 is MP4, the input signal 232 may be a video, if the data type of the input signal 232 is MP3, the input signal 232 may be an audio, and so forth. The data item (e.g., the data item 236C) may match with the input data 235 (e.g., MP4) The controller 208 may further determine that the criticality level of the input signal 232 is the lower criticality level 236N.

Similarly, if the source of the input signal 232 is an imaging unit, the identifier may include “VID” or “MOV”, or the size of the input signal 232 is greater than a predefined threshold size, and the controller 208 may determine that the criticality level of the input signal 232 is the lower criticality level 236N.

Similarly, if the source of the input signal 232 is an audio unit or a microphone, the identifier may include “AUD” or “VOC”, or the size of the input signal 232 may be in a predefined range of size, and the controller 208 may determine that the criticality level of the input signal 232 is the intermediate criticality level 236B.

Similarly, if the source of the input signal 232 is the PASS device 102, the identifier includes “BPM” or “AIR_LOW”, or the size of the input signal 232 is less than the predefined threshold size, and the controller 208 may determine that the criticality level of the input signal 232 is the higher criticality level 236A.

In some embodiments, the controller 208 is configured to determine the criticality level of the input signal 232 based on predefined protocols. In some embodiments, the controller 208 is configured to determine the criticality level of the input signal 232 based on historical data.

In some embodiments, the controller 208 is further configured to determine the criticality level of the input signal 232 based on at least one of the environment of the article 100 (shown in FIG. 1) and the state of health of the article 100.

In some cases, the environment of the article 100 may include environmental conditions, such as a temperature of the environment, a level of smoke or dust in the environment, a level of any gases in the environment, a location of other emergency personnel in the environment, a noise level in the environment, etc. Such environmental conditions may be detected by various sensors, such as temperature sensors, microphones, or pressure sensors disposed on the article 100. In some cases, the input signal 232 may include telemetry data from the various sensors corresponding to the environmental conditions. In such cases, the input signal 232 may have the lower criticality level 236N or the intermediate criticality level 236B.

The input signal 232 including the telemetry data from the various sensors may have a large bandwidth requirement. Therefore, the input signal 232 having the lower criticality level 236N or the intermediate criticality level 236B generally has a larger bandwidth requirement than the input signal 232 having the higher criticality level 236A.

In some cases, the environmental conditions may exceed corresponding predetermined thresholds or levels, and the environmental conditions may be harmful to the user. For example, the environmental conditions may include high noise levels, high ambient temperatures, lack of oxygen, presence of explosives, exposure to radioactive or biologically harmful materials, and exposure to other hazardous substances. In such cases, the input signal 232 may include an emergency signal indicative of such harmful environmental conditions and the input signal 232 may have the higher criticality level 236A.

The input signal 232 including the emergency signal may have a small bandwidth requirement. Therefore, the input signal 232 having the higher criticality level 236A generally has a smaller bandwidth requirement than the lower criticality level 236N or the intermediate criticality level 236B.

In some embodiments, the state of health of the article 100 may include a condition of one or more components of the article 100. For example, a remaining level of air in the air tank 112 (shown in FIG. 1), a battery level of the battery pack of the article 100, and the like.

In some cases, the input signal 232 may include telemetry data corresponding to the condition of the one or more components of the article 100. In such cases, the input signal 232 may have the intermediate criticality level 236B or the lower criticality level 236N.

The input signal 232 including the telemetry data corresponding to the condition of the one or more components of the article 100 may have a large bandwidth requirement. Therefore, the input signal 232 having the intermediate criticality level 236B or the lower criticality level 236N generally has a larger bandwidth requirement than the input signal 232 having the higher criticality level 236A.

In some cases, the condition of the one or more components of the article 100 may cross corresponding predetermined thresholds or levels, and the article 100 may not be able to provide the intended functionality. For example, such conditions may include a low level (e.g., less than 33%) of air in the air tank 112 (shown in FIG. 1). In such cases, the input signal 232 may include a warning signal indicative of such conditions of the one or more components of the article 100 and the input signal 232 may have the higher criticality level 236A.

The input signal 232 including the warning signal may have a small bandwidth requirement. Therefore, the input signal 232 having the higher criticality level 236A generally has a smaller bandwidth requirement than the input signal 232 having the intermediate criticality level 236B or the lower criticality level 236N.

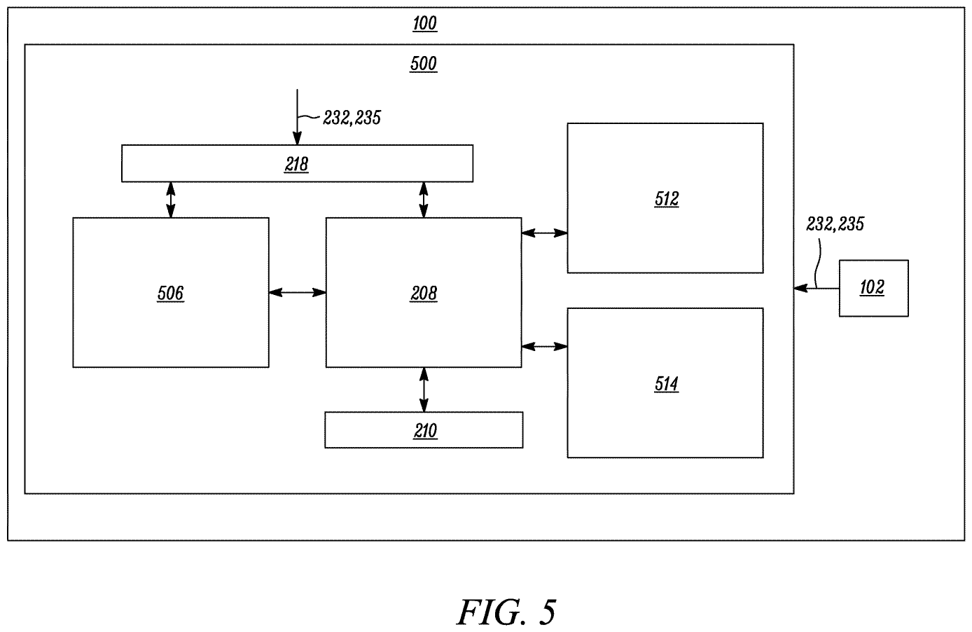

FIG. 5 illustrates a detailed schematic block diagram of the article 100 including the communication device 500 and the PASS device 102, according to another embodiment of the present disclosure. The communication device 500 is substantially similar to the communication device 200 shown in FIG. 2. However, the communication device 500 includes two communication circuits. Specifically, the plurality of communication circuits 212 (shown in FIG. 2) includes a first communication circuit 512 and a second communication circuit 514. The communication device 500 further includes a switching circuit 506. The controller 208 is communicably coupled to the first communication circuit 512, the second communication circuit 514, and the switching circuit 506.

In some embodiments, the communication device 500 includes the transceiver 218 communicably coupled to at least one of the switching circuit 506 and the controller 208. In the illustrated embodiment of FIG. 2, the transceiver 218 is communicably coupled to each of the switching circuit 506 and the controller 208.

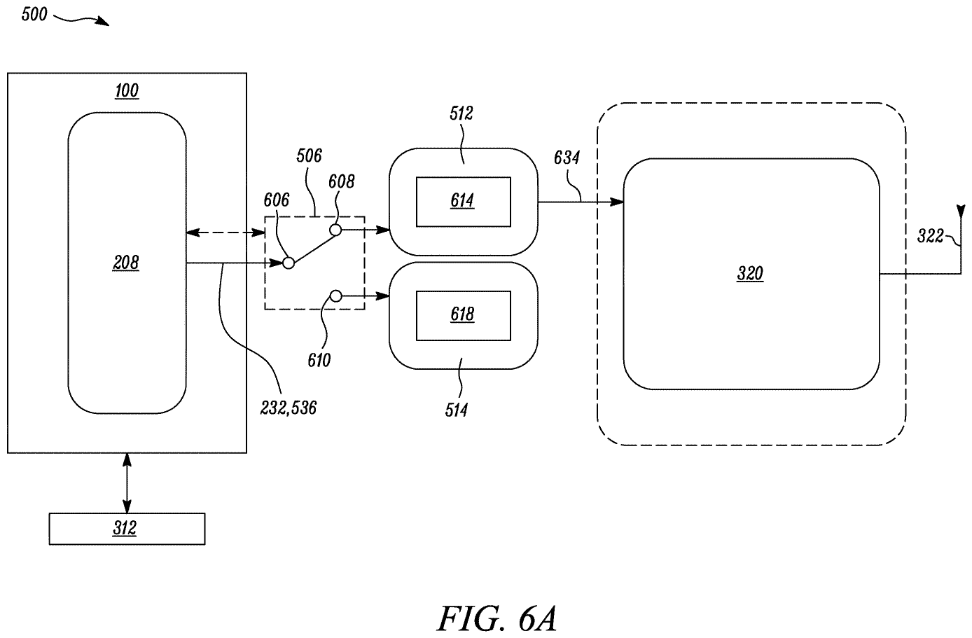

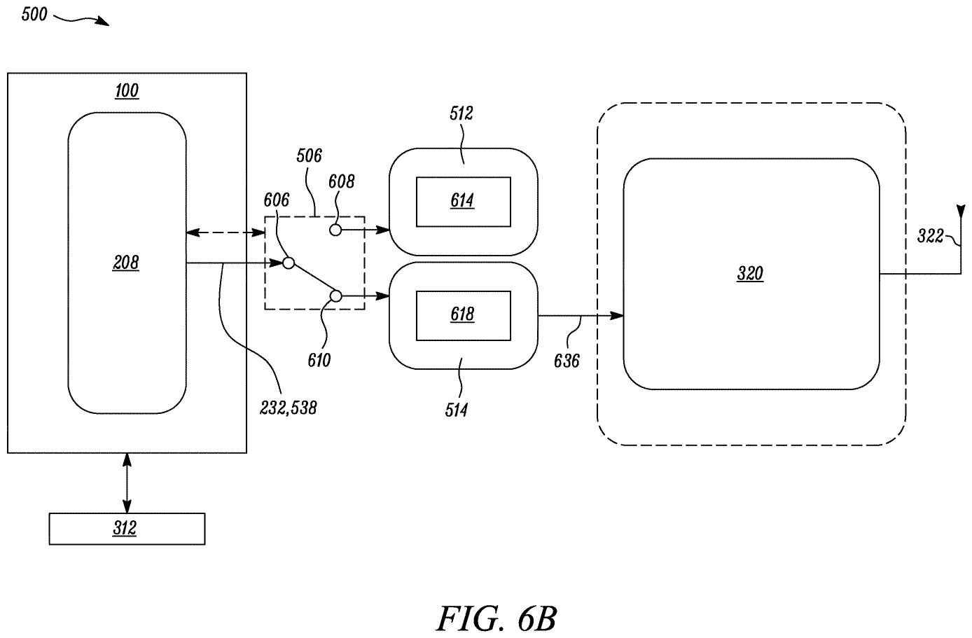

FIG. 6A illustrates a detailed schematic view of the communication device 500. FIG. 6B illustrates a detailed schematic view of the communication device 500 in another state.

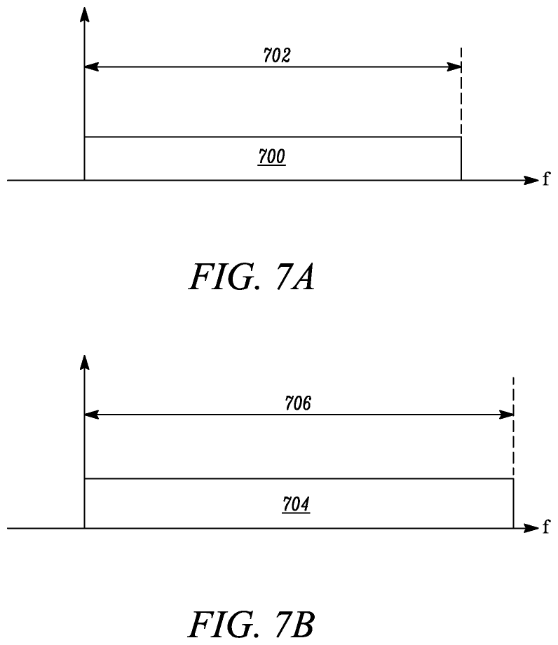

Referring to FIGS. 6A and 7A, the first communication circuit 512 is configured to modulate a signal (e.g., the input signal 232) using a first modulation scheme 614 for transmission over a first communication channel 700. The first communication channel 700 includes a first bandwidth 702.

In some embodiments, the first modulation scheme 614 includes at least one of a LoRa network modulation scheme, a BLE modulation scheme, and a custom modulation scheme. The LoRa network modulation scheme may provide a low-bandwidth and a higher reliability communication. In addition, the LoRa network modulation scheme may provide a higher reliability and a greater range. The first communication circuit 512 configured to modulate the signal using the LoRa network modulation scheme may consume less power, may be small in physical size, and have low cost.

Referring to FIGS. 6A-6B and 7A-7B, the second communication circuit 514 is configured to modulate a signal (e.g., the input signal 232) using a second modulation scheme 618 for transmission over a second communication channel 704. The second communication channel 704 includes a second bandwidth 706 greater than the first bandwidth 702 of the first communication channel 700.

In some embodiments, the second modulation scheme 618 includes a COFDM modulation scheme. The COFDM modulation scheme may provide a high-bandwidth and a lower reliability communication. In some embodiments, the COFDM modulation scheme may reduce the effects of multi-path and doppler effects. In some other embodiments, the second modulation scheme 618 may include Wi-Fi, WiMax, cellular communication (3G, 4G, LTE, 5G), or WAN. In some embodiments, the second modulation scheme 618 may include a custom modulation scheme.

Referring to FIGS. 6A and 6B, the switching circuit 506 is configured to receive the input signal 232. In some embodiments, the switching circuit 506 is configured to receive the input signal 232 from the controller 208. The switching circuit 506 is configured to selectively switch between the first communication circuit 512 and the second communication circuit 514.

In some embodiments, the switching circuit 506 includes an input terminal 606 configured to receive the input signal 232. The switching circuit 506 further includes a first output terminal 608 communicably coupled to the first communication circuit 512 and a second output terminal 610 communicably coupled to the second communication circuit 514.

The controller 208 is further configured to control the switching circuit 506 to selectively couple one of the first output terminal 608 and the second output terminal 610 to the input terminal 606.

The switching circuit 506 may provide selective coupling of the first output terminal 608 and the second output terminal 610 to the input terminal 606. Any suitable switching circuit capable of providing selective coupling described above may be used as the switching circuit 506. The switching circuit 506 may be substantially similar to the switching circuit 206. However, the plurality of output terminals 308 includes the first output terminal 608 and the second output terminal 610.

As discussed above, the controller 208 is configured to determine the criticality level of the input signal 232. The criticality level may include only two levels. For example, in some cases, the critical level includes a higher criticality level 536 and a lower criticality level 538. The higher criticality level 536 may correspond to the higher criticality level 236A (shown in FIG. 3A), as discussed above. The lower criticality level 538 may correspond to the lower criticality level 236N (shown in FIG. 3C), as discussed above. At least one of the higher criticality level 536 and the lower criticality level 538 may include the intermediate criticality level 236B (shown in FIG. 3B). In some examples, the lower criticality level 538 may include the intermediate criticality level 236B.

The controller 208 is further configured to control the switching circuit 506 to switch between the first communication circuit 512 and the second communication circuit 514 based on the criticality level of the input signal 232, such that one of the first communication circuit 512 and the second communication circuit 514 receives the input signal 232.

In some embodiments, the controller 208 is configured to control the switching circuit 506 to switch to the first communication circuit 512, such that the first communication circuit 512 receives the input signal 232 upon determining that the input signal 232 has the higher criticality level 536.

In some embodiments, the controller 208 is configured to control the switching circuit 506 to switch to the second communication circuit 514, such that the second communication circuit 514 receives the input signal 232 upon determining that the input signal 232 has the lower criticality level 538.

In the illustrated embodiment of FIG. 6A, the input signal 232 has the higher criticality level 536. Therefore, the switching circuit 506 switches to the first communication circuit 512, such that the first communication circuit 512 receives the input signal 232. Specifically, the controller 208 controls the switching circuit 506 to selectively couple the first output terminal 608 to the input terminal 606.

In the illustrated embodiment of FIG. 6B, the input signal 232 has the lower criticality level 538. Therefore, the switching circuit 506 switches to the second communication circuit 514, such that the second communication circuit 514 receives the input signal 232. Specifically, the controller 208 controls the switching circuit 506 to selectively couple the second output terminal 610 to the input terminal 606.

In some embodiments, the communication device 500 includes the transceiver 320 communicably coupled to each of the first communication circuit 512 and the second communication circuit 514. The transceiver 320 is configured to wirelessly transmit a first output signal 634 received from the first communication circuit 512 and a second output signal 636 received from the second communication circuit 514.

In the illustrated embodiment of FIG. 6A, the transceiver 320 receives the first output signal 634 from the first communication circuit 512 as the first communication circuit 512 modulates the input signal 232 having the higher criticality level 536 using the first modulation scheme 614 for transmission over the first communication channel 700 (shown in FIG. 7A).

In the illustrated embodiment of FIG. 3B, the transceiver 320 receives the second output signal 636 from the second communication circuit 514 as the second communication circuit 514 modulates the input signal 232 having the lower criticality level 538 using the second modulation scheme 618 for transmission over the second communication channel 704 (shown in FIG. 7B).

In some embodiments, at least one of the first and second communication circuits 512, 514, and the transceiver 320 includes a SDR. In some embodiments, the communication device 500 may be configured to exchange data with the one or more devices of personnel in the environment, the one or more devices of personnel remote from the environment, and/or the central base station, via the antenna 322. In other words, the communication device 500 may include the antenna 322 for connecting the communication device 500 with the network. The network may transmit computer program instructions, data structures, program modules or other data over a wired or wireless substance by propagating a modulated data signal (e.g., the first and second output signals 634, 636), over the wired or wireless substance.

FIGS. 7A and 7B illustrate schematic views of the first communication channel 700 and the second communication channel 704, respectively, according to an embodiment of the present disclosure. The first bandwidth 702 and the second bandwidth 706 of the first communication channel 700 and the second communication channel 704, respectively are depicted in frequency. As discussed above, the second bandwidth 706 is greater than the first bandwidth 702. In some embodiments, the first bandwidth 702 and the second bandwidth 706 may at least partially overlap. In some other embodiments, the first bandwidth 702 and the second bandwidth 706 may not overlap.

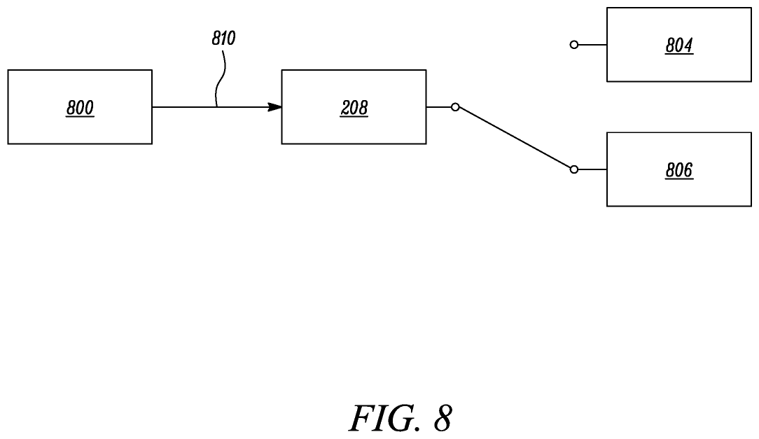

FIG. 8 illustrates a schematic diagram of an administrative device 800 and the controller 208, according to an embodiment of the present disclosure.

In some embodiments, there may be two modes of operation of the communication device 200 (shown in FIG. 2) or the communication device 500 (shown in FIG. 5). The two modes of operation will be described with reference to the communication device 500.

In some embodiments, the two modes may include a normal mode 804 and an administrative mode 806. In some embodiments, the controller 208 is configured to switch between the normal mode 804 and the administrative mode 806.

In the normal mode 804, the controller 208 is configured to control the switching circuit 506 (shown in FIG. 5) based on the criticality level of the input signal 232, as described above.

In the administrative mode 806, the controller 208 is configured to control the switching circuit 506 based on an administration signal 810 received from the administrative device 800.

In some embodiments, the administrative device 800 may be a hand-held device. In some embodiments, the administrative device 800 may be the PDA device 105 (shown in FIG. 1). In some embodiments, the administrative device 800 may be the PASS device 102 (shown in FIG. 1). In some embodiments, the administrative device 800 may be disposed at the central base station and operated by personnel at the central base station.

In some embodiments, the administrative device 800 may be manually operated by the user or the personnel at the central base station to generate the administration signal 810. In some embodiments, the administration signal 810 may include a voice command.

In some embodiments, the administrative device 800 may be automatically switched to the administrative mode 806 based on the administration signal 810 which may be generated periodically after a predetermined interval of time, for example, 10 minutes, 15 minutes, or 30 minutes. In some embodiments, the administrative device 800 may be automatically switched to the administrative mode 806 based on the administration signal 810 which may be generated based on a location of the article 100.

Therefore, in the administrative mode 806, the controller 208 is configured to control the switching circuit 506 based the location of the article 100 and/or the time. In some embodiments, in the administrative mode 806, the controller 208 is configured to control the switching circuit 506 based on a user input provided by the user.

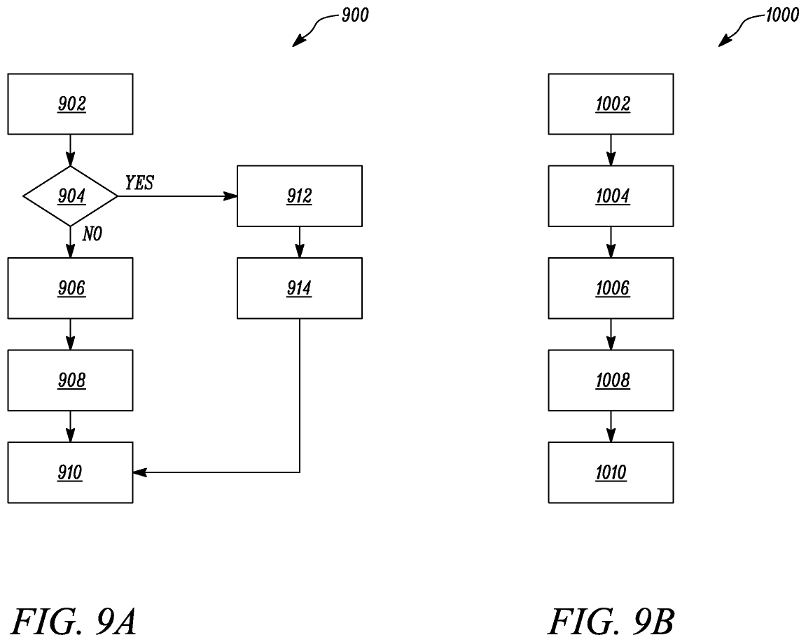

FIGS. 9A and 9B illustrate processes 900, 1000 executed by the communication device 500 (shown in FIG. 5) in the normal mode 804 and in the administrative mode 806, respectively, according to an embodiment of the present disclosure. Specifically, FIGS. 9A and 9B illustrate the processes 900, 1000 executed by the controller 208 (shown in FIG. 5) of the communication device 500 in the normal mode 604 and in the administrative mode 806, respectively.

Referring to FIGS. 2-8 and 9A, at block 902, the process 900 includes receiving the input signal 232 by the article 100.

At block 904, the process 900 includes determining the criticality level of the input signal 232. Specifically, at block 904, the process 900 determines if the criticality level of the input signal 232 is the higher criticality level 536.

In a first example, the criticality level includes the lower criticality level 538. If the criticality level includes the lower criticality level 538, the process 900 moves to block 906.

In a second example, the criticality level includes the higher criticality level 536. If the criticality level includes the higher criticality level 536, the process 900 moves to block 912.

At block 906, the process 900 includes controlling the switching circuit 506 to switch to the second communication circuit 514, as shown in FIG. 6B.

At block 908, the process 900 includes modulating the input signal 232 using the second modulation scheme 618 to generate the second output signal 636.

At block 912, the process 900 includes controlling the switching circuit 506 to switch to the first communication circuit 512, as shown in FIG. 6A.

At block 914, the process 900 includes modulating the input signal 232 using the first modulation scheme 614 to generate the first output signal 634.

At block 910, the process 900 includes transmitting the second output signal 636 modulated using the second modulation scheme 618 or the first output signal 634 modulated using the first modulation scheme 614.

Referring to FIGS. 2-8 and 9B, at block 1002, the process 1000 includes receiving a first trigger signal from the administrative device 800. In some embodiments, the administration signal 810 may include the first trigger signal.

At block 1004, the process 1000 includes switching from the normal mode 804 to the administrative mode 806 upon receiving the first trigger signal from the administrative device 800.

At block 1006, the process 1000 includes modulating the input signal 232 using the first modulation scheme 614 or the second modulation scheme 618 based on the administration signal 810.

At block 1008, the process 1000 includes transmitting the first output signal 634 modulated using the first modulation scheme 614 or the second output signal 636 modulated using the second modulation scheme 618.

At block 1010, the process 1000 includes switching from the administrative mode 806 to the normal mode 804 upon receiving a second trigger signal from the administrative device 600. In some embodiments, the administration signal 810 may include the second trigger signal.

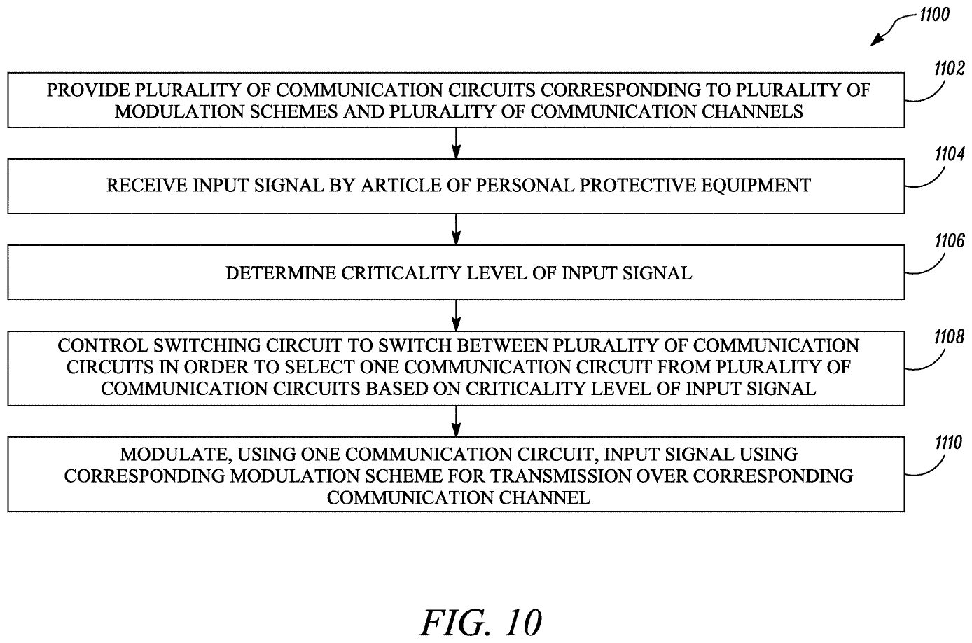

FIG. 10 illustrates a method 1100 of communication for the article 100 (shown in FIG. 1), according to an embodiment of the present disclosure. In some embodiments, the method 1100 may correspond to the process 900 (shown in FIG. 9A). In other words, the method 1100 may correspond to the process 900 executed by the communication device 200 (shown in FIG. 2) or the communication device 500 (shown in FIG. 5) in the normal mode 804. In some embodiments, the method 1100 may correspond to the process 1000 (shown in FIG. 9B). In other words, the method 1100 may correspond to the process 1000 executed by the communication device 200 or the communication device 500 in the administrative mode 806. The method 1100 is described with reference to the communication devices 200, 500.

Referring to FIGS. 2-8 and 10, at step 1102, the method 1100 includes providing the plurality of communication circuits 212 corresponding to the plurality of modulation schemes 314 and the plurality of communication channels. The plurality of communication channels includes different bandwidths from each other. Each communication circuit 212 is configured to modulate a signal using the corresponding modulation scheme from the plurality of modulation schemes 314 for transmission over the corresponding communication channel from the plurality of communication channels.

At step 1104, the method 1100 includes receiving the input signal 232 by the article 100.

At step 1106, the method 1100 includes determining the criticality level of the input signal 232.

At step 1108, the method 1100 includes controlling the switching circuit 206 to switch between the plurality of communication circuits 212 in order to select the one communication circuit from the plurality of communication circuits 212 based on the criticality level of the input signal 232, such that the one communication circuit receives the input signal 232.

At step 1110, the method 1100 includes modulating, using the one communication circuit, the input signal 232 using the corresponding modulation scheme for transmission over the corresponding communication channel.

In some embodiments, controlling the switching circuit 206 to switch between the plurality of communication circuits 212 further includes selecting one of the first communication circuit 512 and the second communication circuit 514 based on the criticality level of the input signal 232.

In some embodiments, modulating the input signal 232 further includes modulating the input signal 232 using the first modulation scheme 614 or the second modulation scheme 618 based on the criticality level of the input signal 232. The first modulation scheme 614 corresponds to the first communication channel 700 having the first bandwidth 702 and the second modulation scheme 618 corresponds to the second communication channel 704 including the second bandwidth 706 greater than the first bandwidth 702.

In some embodiments, the method 1100 further includes, upon determining that the input signal 232 has the higher criticality level 536, switching to the first modulation scheme 614, such that the first modulation scheme 614 modulates the input signal 232.

In some embodiments, the method 1100 further includes, upon determining that the input signal 232 has the lower criticality level 538, switching to the second modulation scheme 618, such that the second modulation scheme 618 modulates the input signal 232.

In some embodiments, the method 1100 further includes accessing the predetermined lookup table 304 including the plurality of data items (e.g., the data items 234A, 234B, 236C) and the corresponding criticality levels of the plurality of data items.

In some embodiments, the method 1100 includes determining the criticality level of the input signal 232 further based on the match between the input data 235 and the plurality of data items in the predetermined lookup table 304.

In some embodiments, determining the criticality level of the input signal 232 is further based on at least one of the environment of the article 100 and the state of health of the article 100.

In some embodiments, the method 1100 further includes wirelessly transmitting the first output signal 634 modulated using the first modulation scheme 614.

In some embodiments, the method 1100 further includes wirelessly transmitting the second output signal 636 modulated using the second modulation scheme 618.

In some embodiments, the method 1100 further includes switching between the normal mode 804 and the administrative mode 806.

In the normal mode 804, controlling the switching circuit 206 to switch between the plurality of communication circuits 212 is based on the criticality level of the input signal 232.

In some embodiments, in the normal mode 804, the method 1100 includes modulating the input signal 232 using the first modulation scheme 614 or the second modulation scheme 618 based on the criticality level of the input signal 232.

In some embodiments, in the administrative mode 806, controlling the switching circuit 206 to switch between the plurality of communication circuits 212 is based on the administration signal 810 received from the administrative device 800.

In some embodiments, in the administrative mode 806, the method 1100 includes modulating the input signal 232 using the first modulation scheme 614 or the second modulation scheme 618 based on the administration signal 810 received from the administrative device 800.

In some embodiments, the method 1100 further includes switching from the normal mode 804 to the administrative mode 806 upon receiving the first trigger signal from the administrative device 800.

In some embodiments, the method 1100 further includes switching from the administrative mode 806 to the normal mode 804 upon receiving the second trigger signal from the administrative device 800.

The communication devices 200, 500 for the article 100, the article 100 including the communication device 200 or the communication device 500, and the method 1100 of communication for the article 100 may allow dynamic selection of an appropriate modulation scheme from the plurality of modulation schemes 314 (e.g., the first or second modulation schemes 614, 618) depending on the criticality level of the input signal 232. This may allow a reliable communication of the input signal 232 having the different criticality levels 236 (e.g., the higher criticality level 536 and the lower criticality level 538) between the article 100 and one or more devices of personnel in the environment, the one or more devices of personnel remote from the environment, and/or the central base station, via a single device (i.e., the communication device 200 or the communication device 500). In other words, two or more separate communication devices may not be required to transmit the input signal 232 having the different criticality levels 236. Therefore, the communication devices 200, 500 may be cheaper than the two or more separate communication devices, may have a less power requirement than the two or more separate communication devices, and may have a reduced size than the two or more separate communication devices. Further, the communication devices 200, 500 may not cause an interference as caused by the two or more separate communication devices.

The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A communication device for an article of personal protective equipment, the communication device comprising:
a plurality of communication circuits corresponding to a plurality of modulation schemes and a plurality of communication channels, the plurality of communication channels comprising different bandwidths from each other, wherein each communication circuit is configured to modulate a signal using a corresponding modulation scheme from the plurality of modulation schemes for transmission over a corresponding communication channel from the plurality of communication channels;
a switching circuit configured to selectively switch between the plurality of communication circuits, wherein the switching circuit is configured to receive an input signal; and
a controller communicably coupled with the plurality of communication circuits and the switching circuit, wherein the controller is configured to:
determine a criticality level of the input signal; and
control the switching circuit to switch between the plurality of communication circuits and select one communication circuit from the plurality of communication circuits based on the criticality level of the input signal, such that the one communication circuit receives the input signal and modulates the input signal using the corresponding modulation scheme for transmission over the corresponding communication channel.

2. The communication device of claim 1, wherein the plurality of communication circuits comprises:
a first communication circuit configured to modulate the signal using a first modulation scheme for transmission over a first communication channel, wherein the first communication channel comprises a first bandwidth; and
a second communication circuit configured to modulate the signal using a second modulation scheme for transmission over a second communication channel, wherein the second communication channel comprises a second bandwidth greater than the first bandwidth of the first communication channel,
wherein the switching circuit is configured to selectively switch between the first communication circuit and the second communication circuit, and wherein the controller is communicably coupled with the first communication circuit and the second communication circuit and configured to:
control the switching circuit to switch between the first communication circuit and the second communication circuit based on the criticality level of the input signal, such that one of the first communication circuit and the second communication circuit receives the input signal.

3. The communication device of claim 2, wherein the criticality level comprises a higher criticality level and a lower criticality level, and wherein the controller is further configured to:
control the switching circuit to switch to the first communication circuit, such that the first communication circuit receives the input signal upon determining that the input signal has the higher criticality level; and
control the switching circuit to switch to the second communication circuit, such that the second communication circuit receives the input signal upon determining that the input signal has the lower criticality level.

4. The communication device of claim 2, wherein the first modulation scheme comprises at least one of a long range (LoRa) network modulation scheme, a Bluetooth low energy (BLE) modulation scheme, and a custom modulation scheme.

5. The communication device of claim 2, wherein the second modulation scheme comprises at least one of a coded orthogonal frequency-division multiplexing (COFDM) modulation scheme, Wi-Fi, WiMax, cellular communication, wide area network (WAN), and a custom modulation scheme.

6. The communication device of claim 1, further comprising a memory communicably coupled to the controller and configured to store a predetermined lookup table comprising a plurality of data items and corresponding criticality levels of the plurality of data items, wherein the input signal comprises an input data, and wherein the controller is further configured to determine the criticality level of the input signal based on a match between the input data and the plurality of data items in the predetermined lookup table.

7. The communication device of claim 1, wherein the controller is further configured to determine the criticality level of the input signal based on at least one of:
an environment of the article of personal protective equipment; and
a state of health of the article of personal protective equipment.

8. The communication device of claim 1, wherein the switching circuit comprises an input terminal configured to receive the input signal and a plurality of output terminals corresponding to the plurality of communication circuits, and wherein the controller is further configured to control the switching circuit to selectively couple one output terminal from the plurality of output terminals to the input terminal.

9. The communication device of claim 1, wherein the input signal is received from at least one of the article of personal protective equipment and an external device communicably coupled to the article of personal protective equipment.

10. The communication device of claim 1, further comprising a transceiver communicably coupled to each of the plurality of communication circuits, wherein the transceiver is configured to wirelessly transmit an output signal received from the one communication circuit.

11. The communication device of claim 10, wherein at least one of: the plurality of communication circuits, the switching circuit, and the transceiver comprises a software-defined radio (SDR).

12. The communication device of claim 1, further comprising a transceiver communicably coupled to at least one of the switching circuit and the controller, wherein the transceiver is configured to wirelessly receive the input signal.

13. The communication device of claim 1, wherein the controller is configured to switch between a normal mode and an administrative mode, wherein, in the normal mode, the controller is configured to control the switching circuit based on the criticality level of the input signal, and wherein, in the administrative mode, the controller is configured to control the switching circuit based on an administration signal received from an administrative device.

14. An article of personal protective equipment comprising the communication device of claim 1.

15. The article of personal protective equipment of claim 14, further comprising a personal alert safety system (PASS) device communicably coupled to the communication device and configured to generate the input signal.

16. The article of personal protective equipment of claim 14, wherein the article of personal protective equipment comprises a self-contained breathing apparatus (SCBA).

17. A method of communication for an article of personal protective equipment, the method comprising:
providing a plurality of communication circuits corresponding to a plurality of modulation schemes and a plurality of communication channels, the plurality of communication channels comprising different bandwidths from each other, wherein each communication circuit is configured to modulate a signal using a corresponding modulation scheme from the plurality of modulation schemes for transmission over a corresponding communication channel from the plurality of communication channels;
receiving an input signal by the article of personal protective equipment;
determining a criticality level of the input signal;
controlling a switching circuit to switch between the plurality of communication circuits in order to select one communication circuit from the plurality of communication circuits based on the criticality level of the input signal, such that the one communication circuit receives the input signal; and
modulating, using the one communication circuit, the input signal using the corresponding modulation scheme for transmission over the corresponding communication channel.

18. The method of claim 17, wherein the plurality of communication circuits comprises a first communication circuit having a first modulation scheme and a second communication circuit having a second modulation scheme, wherein controlling the switching circuit to switch between the plurality of communication circuits further comprises selecting one of the first communication circuit and the second communication circuit based on the criticality level of the input signal, wherein modulating the input signal further comprises modulating the input signal using the first modulation scheme or the second modulation scheme based on the criticality level of the input signal, wherein the first modulation scheme corresponds to a first communication channel comprising a first bandwidth, and wherein the second modulation scheme corresponds to a second communication channel comprising a second bandwidth greater than the first bandwidth.

19. The method of claim 18, wherein the criticality level comprises a higher criticality level and a lower criticality level, and wherein the method further comprises:
upon determining that the input signal has the higher criticality level, switching to the first modulation scheme, such that the first modulation scheme modulates the input signal; and
upon determining that the input signal has the lower criticality level, switching to the second modulation scheme, such that the second modulation scheme modulates the input signal.

20. The method of claim 18, wherein the first modulation scheme comprises at least one of a long range (LoRa) network modulation scheme, a Bluetooth low energy (BLE) modulation scheme, and a custom modulation scheme.

21-28. (canceled)
